(19) United States
(12) Patent Application Publication
(10) Pub. No.: US 2024/0124760 A1
(43) Pub. Date: Apr. 18, 2024

(54) METHOD TO ATTENUATE ACID REACTIVITY DURING ACID STIMULATION OF CARBONATE RICH RESERVOIRS

(71) Applicant: ARAMCO SERVICES COMPANY, Houston, TX (US)

(72) Inventors: Amy J. Cairns, Houston, TX (US); Ayrat Gizzatov, Winchester, MA (US); Rajesh Kumar Saini, Cypress, TX (US); Mohammed Sayed, Katy, TX (US)

(73) Assignee: ARAMCO SERVICES COMPANY, Houston, TX (US)

(21) Appl. No.: 18/532,840

(22) Filed: Dec. 7, 2023

Related U.S. Application Data
(62) Division of application No. 17/654,475, filed on Mar. 11, 2022.
(60) Provisional application No. 63/160,244, filed on Mar. 12, 2021.

(51) Int. Cl. C09K 8/528; E21B 43/28

(52) U.S. Cl. CPC C09K 8/528; E21B 43/28

(57) ABSTRACT

Acidizing treatments for carbonate reservoir may include a surfactant comprising one or more of C₈-C₃₀-alkyloxyglycoside-substituted hydroxysultaine, C₈-C₃₀-alkylamidopropyl hydroxysulfobetaine, poly(diallyldimethylammonium chloride), C₈-C₃₀-alkyl amido alkylamine oxide, C₈-C₃₀-alkyl-amido amine oxide, C₈-C₃₀-alkyl amine oxide, C₈-C₃₀-alkyl aryl amine oxide, C₈-C₃₀-alkyl polyether phosphate, C₈-C₃₀-alkyl polyether phosphonate, C₈-C₃₀-alkyl ether phosphonate, C₈-C₃₀-alkyl amido ammonium propyl sulfonate, C₈-C₃₀-alkyl amido ammonium vinyl sulfonate, C₈-C₃₀-alkyl ether sulfonate, C₈-C₃₀-alkyl amido ammonium propyl sulfonate, C₈-C₃₀-alkyl ether sulfonate, alpha olefin sulfonate, C₈-C₃₀-alkyl benzene sulfonate, C₈-C₃₀-alkyl ethoxy carboxylate, C₈-C₃₀-alkylphenol ethoxylate carboxylate, and C₈-C₃₀-alkyl amido ammonium carboxylate. These acidizing treatments may also include an aqueous acid solution or mixture. In these acidizing treatments, the surfactant may be configured to partially or fully adsorb on a carbonate formation to retard the partial dissolution of the formation. Corresponding methods of reducing the reactivity of acidizing treatment may include introducing these acidizing treatments into wellbores such that the acidizing treatments contact carbonate formations.

### BACKGROUND

In order to increase hydrocarbon production in carbonate formations, treatments are often performed with acids, such as inorganic acids, organic acids, or a combination of both. These acids may be selected based on their reactivity with the rock matrix in the carbonate formations. Matrix stimulation treatments may be performed by injecting these acids through wellbores to react with and dissolve parts of the carbonate formations. In successful treatments, the dissolution process results in the formation of highly conductive channel networks, thereby enhancing hydrocarbon production. Such acid stimulation may be carried out in formations including calcite, dolomite, and the like, using strong mineral acids. For instance, hydrochloric acid (HCl) may be chosen because of its low cost and effectiveness in dissolving calcium and magnesium carbonates. Moreover, the reaction products resulting from the dissolution are readily soluble in water, which may be advantageous in preventing damage of the formation.

However, HCl is very reactive with calcite-rich rock matrices, particularly at elevated temperatures. This may result in significant operational limitations in terms of performance or cost. For instance, radial penetration of the rock matrix is limited even when large volumes of HCl are used because HCl reacts rapidly with the rock matrix before achieving deep penetration. Other limitations may include various safety concerns associated with the transfer and handling of highly corrosive HCl at the well site. As well, undesired acid reactions occurring near the wellbore may cause corrosion and damage to drilling equipment, metal tubulars, and casing, which may result in safety issues for operators in addition to driving up the cost of the treatment because corrosion inhibitor packages will need to be added to the acid treatment. Additionally, corrosion inhibitors may lead to formation damage which, if not addressed, can reduce permeability in the reservoir thereby limiting hydrocarbon production.

### SUMMARY

Certain embodiments of the disclosure will be described with reference to the accompanying drawings, where like reference numerals denote like elements. It should be understood, however, that the accompanying figures illustrate the various implementations described and are not meant to limit the scope of various technologies described.

In one aspect, embodiments disclosed herein are directed to acidizing treatments for carbonate reservoir. The acidizing treatments may include a surfactant comprising one or more of C₈-C₃₀-alkyloxyglyco side-substituted hydroxysultaine, C₈-C₃₀-alkylamidopropyl hydroxysulfobetaine, poly(diallyldimethylammonium chloride), C₈-C₃₀-alkyl amido alkylamine oxide, C₈-C₃₀-alkyl-amido amine oxide, C₈-C₃₀-alkyl amine oxide, C₈-C₃₀-alkyl aryl amine oxide, C₈-C₃₀-alkyl polyether phosphate, C₈-C₃₀-alkyl polyether phosphonate, C₈-C₃₀-alkyl ether phosphonate, C₈-C₃₀-alkyl amido ammonium propyl sulfonate, C₈-C₃₀-alkyl amido ammonium vinyl sulfonate, C₈-C₃₀-alkyl ether sulfonate, C₈-C₃₀-alkyl amido ammonium propyl sulfonate, C₈-C₃₀-alkyl ether sulfonate, alpha olefin sulfonate, C₈-C₃₀-alkyl benzene sulfonate, C₈-C₃₀-alkyl ethoxy carboxylate, C₈-C₃₀-alkylphenol ethoxylate carboxylate, and C₈-C₃₀-alkyl amido ammonium carboxylate. The acidizing treatments may also include an aqueous acid solution or mixture. In these acidizing treatments, the surfactant may be configured to partially or fully adsorb on a carbonate formation to retard the partial dissolution of the formation.

In another aspect, embodiments disclosed herein are directed to methods of reducing the reactivity of acidizing treatments. The methods may include introducing acidizing treatments as described into wellbores such that these acidizing treatments contact carbonate formations.

Other aspects and advantages of this disclosure will be apparent from the following description made with reference to the accompanying drawings and the appended claims.

### BRIEF DESCRIPTION OF DRAWINGS

FIGS. 1A-1D are photographs of core samples in acid solutions having the formulations 25 (FIG. 1A), 19 (FIG. 1B), 23 (FIG. 1C), and 3 (FIG. 1D) of Example 1, Table 2.

FIGS. 2A-2B are photographs of the front and side views, respectively, of a core sample that have been in contact with Formulation 16.

### DETAILED DESCRIPTION

Several strategies have been employed for retarding the reaction rate between the acid and the rock matrix. For example, the acid may be encapsulated or emulsified such that a temporary barrier in the form of a polymer-type shell or coating, an acid-in-diesel (a water-in-oil) emulsion, foaming of the acid, or gelled systems. When the acid is encapsulated or emulsified, stimuli changes, such as temperature, pressure, pH, or shear, may be used to trigger the release of the acid. Alternative strategies have included the use of organic acids or retarding agents. However, limitations still exist, such as the high friction pressures resulting from pumping of emulsified acid systems and the low dissolving power relative to mineral acids. The solubility of the resultant products of organic acids with the matrix material may also be limited.

Accordingly, there exists a need for improved matrix acidization and stimulation treatments of carbonate rich reservoirs.

One or more embodiments of the present disclosure relate to compositions and methods for reducing the reaction rate between an acid, such as HCl, and a carbonate formation material matrix through the addition of surfactant compounds, which may be anionic, cationic, non-ionic, zwitterionic, and combinations thereof. Specifically, one or more embodiments relate to aqueous treatments for downhole applications, including a surface-active ingredient containing an amphiphilic surfactant and an acid in an aqueous solution, where the hydrophilic group bearing the head moiety is configured to adsorb onto the formation surface while the hydrophobic group bearing the tail moiety is designed to repel the acid-containing aqueous phase thereby providing a temporary barrier on the rock surface.

The compositions and methods for reducing the reaction rate between an acid and the carbonate surface of a formation matrix leaves portions of the carbonate surface not covered with surfactant, thereby permitting acid to react and dissolve the portions of the carbonate surface exposed and penetrate into the formation matrix. The partial exposure of carbonate surface and the activity of the acid permits the creation of irregular or random channels into the formation matrix, which maximize the fluid conductivity of the resulting channels. As such, the compositions and methods of this disclosure do not relate to the diversion of acid to alternate zones in the wellbore but rather the deeper penetration of the formation matrix in the treated zone versus other systems and methods.

The presence of a surface active ingredient, i.e. a surfactant molecule in an aqueous composition containing an acid used for the production of hydrocarbons from carbonate formations, via a matrix acidizing or acid fracturing treatment, may act as a retarding agent that can effectively slow down the acid (such as HCl) reaction rate towards a carbonate surface without compromising its strength. Specifically, the surfactant may be adsorbed onto the surface of the carbonate formation, which has been modified by adsorbing surfactant molecules, resulting in a retardation effect due to the lack of access to the rock matrix by the acid.

The surfactant may include one or more of C₈-C₃₀-alkyloxyglycoside-substituted hydroxysultaine, C₈-C₃₀-alkylamidopropyl hydroxysulfobetaine, poly(diallyldimethylammonium chloride), C₈-C₃₀-alkyl amido alkylamine oxide, C₈-C₃₀-alkyl-amido amine oxide, C₈-C₃₀-alkyl amine oxide, C₈-C₃₀-alkyl aryl amine oxide, C₈-C₃₀-alkyl polyether phosphate, C₈-C₃₀-alkyl polyether phosphonate, C₈-C₃₀-alkyl ether phosphonate, C₈-C₃₀-alkyl amido ammonium propyl sulfonate, C₈-C₃₀-alkyl amido ammonium vinyl sulfonate, C₈-C₃₀-alkyl ether sulfonate, C₈-C₃₀-alkyl amido ammonium propyl sulfonate, C₈-C₃₀-alkyl ether sulfonate, alpha olefin sulfonate, C₈-C₃₀-alkyl benzene sulfonate, C₈-C₃₀-alkyl ethoxy carboxylate, C₈-C₃₀-alkylphenol ethoxylate carboxylate, and C₈-C₃₀-alkyl amido ammonium carboxylate.

An alkyl group may be defined as a saturated hydrocarbon group, such as a C₈-C₃₀-alkyl group, that may be linear, branched, or cyclic, such as non-aromatic cyclic. Examples of such groups include, but are not limited to, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, including their substituted analogues. Substituted alkyl groups are groups in which at least one hydrogen atom of the alkyl group has been substituted with at least one functional group, such as NR₂, OR, SeR, TeR, PR₂, AsR₂, SbR₂, SR, BR₂, SiR₃, GeR₃, SnR₃, and PbR₃, or where at least one heteroatom has been inserted within an aryl ring.

In some embodiments, the surfactant may be a zwitterion, defined as a molecule that contains an equal number of positively charged and negatively charged functional groups.

In some embodiments, the surfactant may include compounds of Formula I:

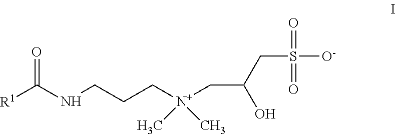

where R¹ is a C₈-C₃₀-alkyl group.

In some embodiments, the surfactants may include a hydrophilic head-group and a hydrophobic tail-group. The hydrophilic head-group may include a charged functional group, such as sulfonate group, phosphonate, or carboxylate group. The hydrophobic tail-group may include an alkyl group, a poly-alkylated aromatic, or a non-aromatic ring system that may be branched or linear.

In some embodiments, the surfactant may include polyol -type compounds of Formula II:

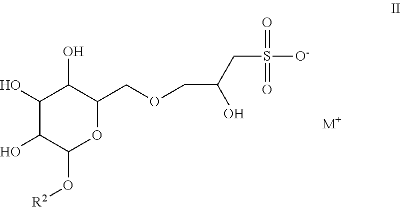

where R² is a C₈-C₃₀-alkyl group, and where M is an alkali metal, such as Na, Li, and K.

In some embodiments, the surfactant may include compounds of Formula III:

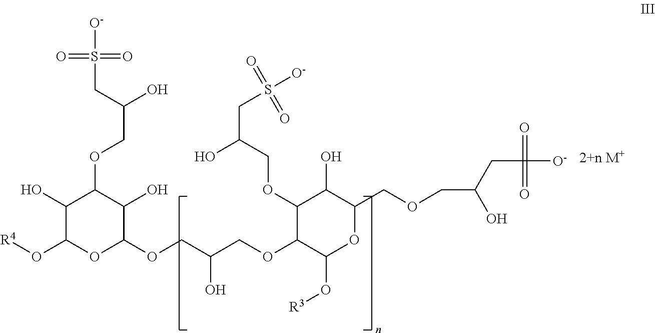

where R³ and R⁴ are each independently C₈-C₃₀-alkyl groups, where n=1 to 30, and where M is an alkali metal, such as Na, Li, and K.

In some embodiments, the surfactant may include a metal sulfonate salt or an ammonium salt comprising one or more N-substituted ammonium salts. In some such embodiments, the N-substituted ammonium salt may be mono-, di-, tri-, or tetra-substituted, with one, two, three, or four alkyl groups, respectively. Alkyl groups include, but are not limited to, methyl, ethyl, propyl, and butyl. In some embodiments, the surfactant may include an ammonium salt comprising a polyquat polymer, such as poly(diallyldimethylammonium chloride).

In some embodiments, the surfactant may include multifunctional, natural triglyceride phospholipids, such as quaternary ammonium compounds. An example of a useful quaternary ammonium compound includes the sodium cocoalkyl(2,3-dihydroxypropyl)dimethyl-3-phosphate ester chloride of Formula IV:

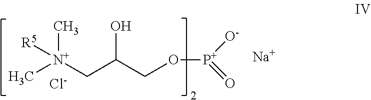

where R⁵ is a C₈-C₃₀-alkyl group.

In some embodiments, the surfactant may include one or more of a C₈-C₃₀-alkyl-ethoxylate-carboxylate, a C₈-C₃₀-alkyl-amido amine oxide, a C₈-C₃₀-alkyl amine oxide, a C₈-C₃₀-alkyl aryl amine oxide, a C₈-C₃₀-alkyl polyether phosphate or phosphonate, a C₈-C₃₀-alkyl amido ammonium carboxylate, or a C₈-C₃₀-alkyl amido ammonium propyl sulfonate.

In some embodiment, the surfactant may include one or more of an alpha olefin sulfonate, alkyl benzene sulfonate, alkyl ether sulfonate, alpha sulfonate methyl ether, sulfoacetate (sodium lauryl sulfoacetate), sulfosuccinate, cocamidopropyl amine oxide, linear alcohol ethoxylate carboxylate, nonylphenol ethoxylate carboxylate, alkyl ether sulfonate, and alkyl ether phosphonate.

In some embodiment, the surfactant may include one or more ether functionalities. Examples of such ether-containing hydrophobically-modified surfactants may include a C₈-C₃₀-alkyloxyglyco side-substituted hydroxysultaine, a C₈-C₃₀-alkyl polyether phosphate, a C₈-C₃₀-alkyl polyether phosphonate, a C₈-C₃₀-alkyl ether phosphonate, a C₈-C₃₀-alkyl ether sulfonate, a C₈-C₃₀-alkyl ethoxy carboxylate, a C₈-C₃₀-alkylphenol ethoxylate carboxylate, and combinations thereof. These ether-containing surfactants may be hydrolyzed or cleaved over time under formation conditions in acidic medium to produce surfactant molecules having a hydrophilic character and a reduced chain length. These hydrolyzed molecules may alter the wettability of the rock surface and leave the surface water wet. These molecules may be advantageous, for example, in hydrocarbon producing reservoirs, upon flow back where it is desirable for the rock surface to be water wet.

In some embodiments, the surfactant may be in an aqueous solution. In some embodiments, the surfactant may be added with an acidic solution in the acidizing treatment so that the surfactant is in an amount sub-stoichiometric compared to the acid. In some embodiments, the surfactant may be added with an acidic solution in the acidizing treatment so that the surfactant is present in the acidizing treatment at a concentration of up to 70 gallons per 1000 gallons (gpt) of acidizing treatment, such as in a range of from about 0.01 to about 70, from about 0.05 to about 60, from about 0.1 to about 50, from about 0.2 to about 40, from about 0.3 to about 30, and from about 0.5 to about 20 gpt. In some embodiments, the acidizing treatment may be added to formations having fractures extending from tens to several hundreds of feet.

When introduced into a wellbore, the surfactants that include a hydrophilic head-group and a hydrophobic tail-group may adhere to the rock surface via surface adsorption resulting from the coordination of the hydrophilic head-groups with the rock surface. The tail-groups are therefore directed outward. The tail-groups induce a hydrophobic character in the vicinity of the rock surface. This hydrophobic character hinders access by water and aqueous solutions of acid to the formation surface. The water or aqueous solution of acid therefore passes deeper into the formation, where it may encounter a portion of formation surface material not hindered by the surfactant and then interact with such surface, including reacting with it.

In some embodiments, the surfactant may be functionalized to promote stronger interaction with the rock matrix, for example, by introducing a greater number of hydrophilic moieties on the surfactants molecule or by introducing functional moieties that will impart covalent and non-covalent interactions with neighboring surfactant molecules adsorbed on the rock surface (for example, pi-pi stacking and hydrogen bonding). The resulting more compact stacking of neighboring surfactant molecules on the rock surface may provide a more effective barrier to water and aqueous solutions of acid and therefore enhance the attenuation effect.

In some embodiments, the surfactants may generate foam, which may be responsible for the attenuation behavior as the presence of foam in the vicinity of the rock surface will provide a temporary barrier between the acid and rock matrix.

In some embodiments, the surfactants may be combined with suitable inorganic or organic acids or acid-producing systems as a means of tailoring the acid reactivity with the rock matrix. In some embodiments, the acidizing treatments of the present disclosure may incorporate an acid in an aqueous solution. The acid may include an inorganic acid, an organic acid, or both. The inorganic acid may include, but are not limited to, HCl, nitric acid, phosphoric acid, hydrofluoric acid, hydrobromic acid, perchloric acid, fluoroboric acid, or derivatives, and mixtures thereof. The organic acid may include, but are not limited to, formic acid, acetic acid, citric acid, lactic acid, sulfamic acid, chloroacetic acid, or derivatives, and mixtures thereof. Acid-producing systems may include, but are not limited to, esters, lactones, anhydrides, orthoesters, polyesters or polyorthoesters. The acid-producing systems may include esters of short chain carboxylic acids, including, but not limited to, acetic and formic acid, and esters of hydroxycarboxylic acids, including, but not limited to, glycolic and lactic acid. These acid-producing systems may provide the corresponding acids when hydrolyzed in the presence of water. The acid may be present in an aqueous composition at a concentration in a range of from about 5 wt % to about 35 wt %, such as from about 7 wt % to about 32 wt %, from about 10 wt % to about 30 wt %, and from about 15 wt % to about 28 wt % (weight percent).

Acidizing treatments described in this disclosure may optionally comprise one or more additives, for example, to improve the compatibility of the fluids described in this application with other fluids (for instance, formation fluids) that may be present in the well bore. Suitable additives may be used in liquid or powder form. Where used, additives are present in the fluids in an amount sufficient to prevent incompatibility with formation fluids or well bore fluids. If included, additives may be in a range of from about 0.01% to about 10% vol % (volume percent) of the total acidizing treatment. In some embodiments, where powdered additives are used, the additives may be present in an amount in the range of from about 0.001 wt % to about 10 wt % of the total acidizing treatment.

In some embodiments, mutual solvents may be employed. Mutual solvents may help keep other additives in solution. Suitable mutual solvents may include, but are not limited to, Halliburton's MUSOL® Mutual Solvent, MUSOL® A Mutual Solvent, MUSOL® E Mutual Solvent, ethyleneglycolmonobutylether, propyleneglycolmonobutylether, water, methanol, isopropyl alcohol, alcohol ethers, aromatic solvents, other hydrocarbons, mineral oils, paraffins, derivatives thereof, and combinations thereof. Other suitable solvents may also be used. If used, the mutual solvent may be included in a range of from about 1 vol % to about 20 vol %, and in certain embodiments in a range of from about 5 vol % to about 10 vol % based on the of the total volume of the acidizing treatment.

In some embodiments, the acidizing treatments may optionally include one or more viscosifying agents. In some embodiments, the acidizing treatment may be viscosified by a polymer system, for instance, a cross-linked polymer system, where the crosslinker comprises zirconium or ferric metal clusters.

In some embodiments, the acidizing treatments may optionally comprise one or more gelling agents. Any gelling agent suitable for use in subterranean applications may be used in the acidizing treatments, including, but not limited to, natural biopolymers, synthetic polymers, cross-linked gelling agents, and viscoelastic surfactants. Guar and xanthan are examples of suitable gelling agents. A variety of gelling agents may be used, including hydratable polymers that contain one or more functional groups such as hydroxyl, carboxyl, sulfate, sulfonate, amino or amide groups. Suitable gelling agents may comprise polysaccharides, biopolymers, synthetic polymers, and a combination thereof. Examples of suitable polymers include, but are not limited to, guar gum and derivatives thereof, such as hydroxypropyl guar and carboxymethylhydroxypropyl guar; cellulose derivatives, such as hydroxyethyl cellulose; locust bean gum; tara; konjak; tamarind; starch; cellulose; karaya; diutan; scleroglucan; wellan; gellan; xanthan; tragacanth; carrageenan; derivatives thereof; and combinations thereof of one or more of such polymers.

Additionally, synthetic polymers and copolymers may be used. Examples of such synthetic polymers include, but are not limited to, polyacrylate, polymethacrylate, polyacrylamide, polyvinyl alcohol, and polyvinylpyrrolidone. Commonly used synthetic polymer acid-gelling agents may include polymers and copolymers having various ratios of acrylic, acrylamide, acrylamidomethylpropane sulfonic acid, quaternized dimethylaminoethylacrylate, and quaternized dimethylaminoethylmethacrylate.

Examples may be shown in these references, the disclosures of which are incorporated herein by reference: Chatterji, J. and Borchardt, J. K.: “Application of Water-Soluble Polymers in the Oilfield,” paper SPE 9288 presented at the 1980 Annual Technical Conference, Dallas, TX, Sept. 21-24; Norman, L. R., Conway, M. W., and Wilson, J. M.: “Temperature-Stable Acid Gelling Polymers: Laboratory Evaluation and Field Results,” paper SPE 10260 presented at the 1981 Annual Technical Conference, San Antonio, TX, Oct. 5-7; Bouwmeester, Ron, C. M. U.S. Patent Application No. 2005/0197257; Tackett, Jr., U.S. Pat. No. 5,082,056; Crowe, Curtis, W. European Patent Application 0 278 540; and Nehmer, Warren L G B 2163790. In other embodiments, the gelling agent molecule may be depolymerized. The term “depolymerized” generally refers to a decrease in the molecular weight of the gelling agent molecule. Depolymerized gelling agent molecules are described in U.S. Pat. No. 6,488,091, the relevant disclosure of which is incorporated herein by reference. If used, a gelling agent may be present in the acid-generating fluids of the acidizing treatments in an amount in the range of from about 0.01 wt % to about 5 wt % of the base fluid.

To combat possible perceived problems associated with polymeric gelling agents, some surfactants have been used as gelling agents. It is well understood that when mixed with a fluid in a concentration greater than the critical micelle concentration the molecules (or ions) of surfactants may associate to form micelles. These micelles may function, among other purposes, to stabilize emulsions, break emulsions, stabilize foam, change the wettability of a surface, solubilize certain materials, and reduce surface tension. When used as a gelling agent, the molecules (or ions) of the surfactants used associate to form micelles of a certain micellar structure (for example, rodlike, wormlike, or vesicles, which are referred to here as “viscosifying micelles”) that, under certain conditions (for example, concentration or ionic strength of the fluid) are capable of, inter alia, imparting increased viscosity to a particular fluid and forming a gel. Certain viscosifying micelles may impart increased viscosity to a fluid such that the fluid exhibits viscoelastic behavior (for example, shear thinning properties) due, at least in part, to the association of the surfactant molecules. Moreover, because the viscosifying micelles may be sensitive to pH and hydrocarbons, the viscosity of these viscoelastic surfactant fluids may be reduced after introduction into the subterranean formation without the need for certain types of gel breakers (for example, oxidizers). A particular surfactant that may be useful is a methyl ester sulfonate (“MES”) surfactant. Suitable MES surfactants include, but are not limited to, methyl ester sulfonate surfactants having the formula RCH(SO₃M)CO₂CH₃, where R is an alkyl chain of about 10 carbon atoms to about 30 carbon atoms. This may allow a substantial portion of the viscoelastic surfactant fluids to be produced back from the formation without the need for expensive remedial treatments. If used, these surfactants may be used in an amount of up to about 10 wt % of the acidizing treatment.

While optional, at least a portion of the gelling agent included in the acidizing treatments may be cross linked by a reaction comprising a cross linking agent, for example, to further increase viscosity. Cross-linking agents typically comprise at least one metal ion that is capable of cross-linking gelling agent molecules. Various cross-linking agents may be suitable; acidizing treatments are not limited by ligand choice on the cross-linking agent. Examples of suitable cross linking agents may include zirconium compounds (such as, zirconium lactate, zirconium lactate triethanolamine, zirconium carbonate, zirconium acetylacetonate, zirconium maleate, zirconium citrate, zirconium oxychloride, and zirconium diisopropylamine lactate); titanium compounds (such as, titanium lactate, titanium maleate, titanium citrate, titanium ammonium lactate, titanium triethanolamine, and titanium acetylacetonate); aluminum compounds (such as, aluminum lactate or aluminum citrate); borate compounds (such as, sodium tetraborate, boric acid, disodium octaborate tetrahydrate, sodium diborate, ulexite, and colemanite); antimony compounds; chromium compounds; iron compounds; copper compounds; zinc compounds; or a combination thereof. An example of a suitable commercially available zirconium-based cross-linking agent is CL24™ cross-linker from Halliburton Energy Services, Inc., Duncan, Oklahoma. An example of a suitable commercially available titanium-based cross-linking agent is CL39™ cross linker from Halliburton Energy Services, Inc., Duncan Oklahoma. An example of a suitable borate-based cross-linking agent is commercially available as CL-22™ delayed borate cross linker from Halliburton Energy Services, Inc., Duncan, Oklahoma. Divalent ions also may be used, for example, calcium chloride and magnesium oxide. An example of a suitable divalent ion cross linking agent is commercially available as CL30™ from Halliburton Energy Services, Inc., Duncan, Oklahoma. Another example of a suitable cross-linking agent is CL-15, from Halliburton Energy Services, Inc., Duncan Oklahoma. Where present, the cross-linking agent generally may be included in the treatment composition in an amount sufficient, among other things, to provide the desired degree of cross linking In some embodiments, the cross-linking agent may be present in the acidizing treatment in an amount in the range of from about 0.01 wt % to about 5 wt % of the total weight of the acidizing treatment. Buffering compounds may be used if desired, for example, to delay or control the cross-linking reaction. These may include, but are not limited to, glycolic acid, carbonates, bicarbonates, acetates, and phosphates. In some embodiments, if a gelling agent (for instance, a cross linked gelling agent) is used, then a suitable breaker may be advisable depending on the gelling agent and its interaction with the acid-generating compound, the generated acid, and the well bore conditions. A breaker may be advisable to ultimately reduce the viscosity of the acidizing treatment. Any breaker suitable for the subterranean formation and the gelling agent may be used. The amount of a breaker to include will depend, inter alia, on the amount of gelling agent present in the acidizing treatment. Other considerations regarding the breaker are known to one skilled in the art.

In one or more embodiments, the acidizing treatments may optionally include one or more bactericides. Bactericides protect both the subterranean formation as well as the fluid from attack by bacteria. Such attacks may be problematic because they may reduce the viscosity of the fluid, resulting in poorer performance, for example. Bacteria may also cause plugging by bacterial slime production and can turn the oil in the formation sour. Any bactericides known in the art are suitable. An artisan of ordinary skill with the benefit of this disclosure will be able to identify a suitable bactericide and the proper concentration of such bactericide for a given application. Where used, such bactericides may be present in an amount sufficient to destroy all bacteria that may be present. Examples of suitable bactericides include, but are not limited to 2,2-dibromo-3-nitrilopropionamide and2-bromo-2-nitro-1,3-propanediol. In one embodiment, the bactericides may be present in the acidizing treatment in an amount in the range of from about 0.001 wt % to about 0.003 wt % based on the total weight of the acidizing treatment. Another example of a suitable bactericide is a solution of sodium hypochlorite. In certain embodiments, such bactericides may be present in the acidizing treatments in an amount in the range of from about 0.01 vol % to about 0.1 vol % based on the total volume of the acidizing treatment.

In one or more embodiments, the acidizing treatments may optionally include additional additives. Examples of such additional additives may include, but are not limited to, oxidizing agents, lost circulation materials, scale inhibitors, surfactants, clay stabilizers, corrosion inhibitors, paraffin inhibitors, asphaltene inhibitors, penetrating agents, clay control additives, iron control additives, reducers, oxygen scavengers, sulfide scavengers, emulsifiers, foamers, gases, derivatives thereof, and combinations thereof.

In some embodiments, the acidizing treatments may optionally include additional additives, such as a foamer. Examples of foamers include, but are not limited to, surfactants, for example, water-soluble, nonionic, anionic, cationic, and amphoteric surfactants; carbohydrates, for example, polysaccharides, cellulosic derivatives, guar, guar derivatives, xanthan, carrageenan, starch polymers, gums, polyacrylamides, polyacrylates, betaine-based surfactants, viscoelastic surfactants, natural and synthetic clays; polymeric surfactants, for example, partially hydrolyzed polyvinyl acetate; partially hydrolyzed modified polyvinyl acetate; block or copolymers of polyethane, polypropane, polybutane and polypentane; proteins; partially hydrolyzed polyvinyl acetate, polyacrylate, and derivatives of polyacrylates; polyvinyl pyrrolidone and derivatives thereof; N₂; CO; CO₂; air; and natural gas; and combinations thereof.

In some embodiments, the present disclosure relates to methods of reducing the reactivity of acidizing treatment, comprising introducing into a wellbore a acidizing treatment containing a and an acid in an aqueous solution, such that that the acidizing treatment contacts the formation, and where the surfactant is configured to adsorb onto the formation surface. These methods attenuate or retard the reaction rate between acid and the rock matrix through the addition of surfactant molecules. These surfactants may be added to an acidic media at low concentrations, for example, up to about 70 gpt, such as in a range of from about 0.01 gpt to about 70 gpt, from about 0.05 gpt to about 60 gpt, from about 0.1 gpt to about 50 gpt, from about 0.2 gpt to about 40 gpt, from abou 0.3 gpt to about 30 gpt, and from about 0.5 gpt to about 20 gpt.

In some embodiments, the step of contacting comprises introducing the aqueous solution into the formation via coiled tubing or bullheading in a production tube.

In some embodiments, the methods may further include the step of combining an aqueous solution of the surfactant and the aqueous solution of acid prior to introducing the acidizing treatment into the wellbore.

In some embodiments, in these methods, the step of contacting may include introducing an aqueous solution of the acid and an aqueous solution of the surfactant into the formation via the same tubing (for example, the same coiled tubing) and allowing the aqueous formation treatment to form in situ within the tubing, within the formation, or within the area around the wellbore.

In some embodiments, in these methods, the step of contacting may include introducing an aqueous solution of surfactant and the aqueous acidic solution into the formation in separate stages, optionally via the same or different tubings, such as the same or different coiled tubings, and allowing the aqueous fluids to mix within the formation. In some embodiments, the aqueous solution of the surfactant may be introduced into the formation first. In some embodiments, the acidic solution/stimulation fluid may be introduced into the formation first.

In some embodiments, in these methods, the acidizing treatment is in contact with the formation for a time ranging from about 1 hour to about 12 hours, or from about 2 hours to about 11 hours, or from about 3 hours to about 10 hours, or from about 4 hours to about 9 hours, or from about 5 hours to about 8 hours, or from about 4 hours to about 8 hours.

In some embodiments, the methods may further include producing hydrocarbons from the carbonate formation, which contain highly conductive channel networks formed by the retarded action of the acid solution within the formation.

### EXAMPLES

The following examples are merely illustrative and should not be interpreted as limiting the scope of the present disclosure.

### Example 1—Core-plug Dissolution Experiments

A series of core-plug dissolution experiments was performed using HCl at varying concentrations with and without surfactants. The surfactants, when used, were also at varying concentrations. Tables 1-3 provide the experimental details showing the dissolution profiles of this series of acid formulations under analogous testing conditions. These conditions included ambient pressure and temperature, fluid volume (250 milliliters (mL)) and exposure time (5 minutes).

The acid formulations were prepared by adding up to 20 gpt of surfactant (if used) to HCl solutions (15 wt %, 26 wt %, and 28 wt %). Surfactants were first added to the water phase, fully dispersed and then the concentrated HCl (36 wt %) added to give the dilution noted. In a typical experiment, the following steps were performed. Homogenous Indiana limestone core samples having a permeability between 4 to 8 millidarcy (mD) were cut to have a diameter and length of 1.5 inch (″) D×0.5″ L, respectively. One core sample was used for each individual test. The cores were dried in the oven at 248 degrees Fahrenheit (° F.) overnight. Each of the dried cores were then saturated in deionized H₂ O (DI-H₂O) under vacuum for 12 to24 hours. The dry and saturated weight for the pre-treated cores were recorded and porosity was calculated. The acid formulations were prepared according to the details listed in Tables 1-3. Each saturated core was transferred to a 500 mL beaker containing 250 milliliters (mL) of each acid formulation. For each experiment, the core sample was placed standing up in the solution to ensure consistency across the series. Digital photos were taken of the cores before and after acidizing. The weight of each of the saturated acidized core samples was measured for both the dry and saturated sample. The percent of the weight loss for each core was calculated and compared. Additionally, for each test, the amount of dissolved calcite (CaCO₃) was calculated using Inductively Coupled Plasma Optical Emission Spectrometry (ICP-OES) measurements by determining the calcium concentration detected from an aliquot of the reaction.

Table 1 provides the calculated weight loss of Indiana limestone core samples, post-acidizing, for acid formulations containing the sole acid, at 15, 26 and 28 wt % HCl, and formulations containing acid solutions at 15 wt % HCl in the presence of cocamidopropyl hydroxysultaine, sodium decylglucosides hydroxypropylsulfonate, sodium laurylglucosides hydroxypropylsulfonate, and sodium hydroxypropylsulfonate laurylglucoside crosspolymer surfactants.

TABLE 1

| | | | Surfactant | |
|---|---|---|---|---|
| | | | Concentration | Calcite |
| | HCl | | (gallons per | Dissolved |
| Formulation | (wt %) | Surfactant | thousand (gpt)) | (%) |
| 1 | 15 | N/A | 0 | 43.7 |
| 2 | 26 | N/A | 0 | 66.6 |
| 3 | 28 | N/A | 0 | 76.2 |
| 4 | 15 | CBS-HP¹ | 20 | 4.64 |
| 5 | 15 | CBS-HP¹ | 10 | 7.82 |
| 6 | 15 | CBS-HP¹ | 2 | 17.4 |
| 7 | 15 | CBS² | 10 | 8.10 |
| 8 | 15 | CCBS³ | 10 | 7.81 |
| 9 | 15 | LMHS⁴ | 10 | 7.48 |
| 10 | 15 | SugaNate 100 NC⁵ | 20 | 6.82 |
| 11 | 15 | SugaNate 100 NC⁵ | 10 | 19.3 |
| 12 | 15 | SugaNate 160 NC⁶ | 20 | 9.14 |
| 13 | 15 | SugaNate 160 NC⁶ | 10 | 10.3 |
| 14 | 15 | PolySugaNate 100 PNC⁷ | 20 | 6.48 |
| 15 | 15 | PolySugaNate 100 PNC⁷ | 2 | 38.2 |
| 16 | 15 | PolySugaNate 100 PNC⁷ | 0.5 | 43.1 |

¹Cola ®Teric Sultaine, glycerin-free sultaine, cocamidopropyl hydroxysultaine (glycerine free), product of Colonial Chemical, USA.
²Cola ®Teric Sultaine, standard sultaine, cocamidopropyl hydroxysultaine, product of Colonial Chemical, USA.
³Cola ®Teric Sultaine, standard sultaine with coconut oil, cocamidopropyl hydroxysultaine, product of Colonial Chemical, USA.
⁴Cola ®Teric Sultaine, mild, high foam, viscosity-boosting glycerin-free sultaine, lauramidopropyl hydroxysultaine, product of Colonial Chemical, USA.
⁵Sodium decylglucosides hydroxypropylsulfonate, product of Colonial Chemical, USA.
⁶Sodium laurylglucosides hydroxypropylsulfonate, product of Colonial Chemical, USA.
⁷Sodium hydroxypropylsulfonate laurylglucoside crosspolymer, product of Colonial Chemical, USA.

The data provided in Table 1 show that the formulations including surfactants resulted in the attenuation of the acid-rock reactivity.

Table 2 provides the calculated weight loss of Indiana limestone core samples, post-acidizing, for acid formulations containing acid solutions at 28 wt % HCl in the presence of cocamidopropyl hydroxysultaine, sodium decylglucosides hydroxypropylsulfonate, sodium laurylglucosides hydroxypropylsulfonate, and sodium hydroxypropylsulfonate laurylglucoside crosspolymer surfactants.

TABLE 2

| | | | Surfactant | Calcite |
|---|---|---|---|---|
| | HCl | | Concentration | Dissolved |
| Formulation | (wt %) | Surfactant | (gpt) | (%) |
| 17 | 28 | PolySugaNate 100 PNC⁷ | 20 | 14.9 |
| 18 | 28 | PolySugaNate 100 PNC⁷ | 10 | 34.9 |
| 19 | 28 | SugaNate 100 NC⁵ | 20 | 12.7 |
| 20 | 28 | SugaNate 100 NC⁵ | 10 | 32.6 |
| 21 | 28 | SugaNate 160 NC⁶ | 20 | 23.0 |
| 22 | 28 | SugaNate 160 NC⁶ | 10 | 25.1 |
| 23 | 28 | CBS-HP¹ | 20 | 5.63 |
| 24 | 28 | CBS-HP¹ | 10 | 9.77 |
| 25 | 28 | CBS-HP¹ | 8 | 9.12 |
| 26 | 28 | CBS-HP¹ | 5 | 23.6 |

¹Cola ®Teric Sultaine, glycerin-free sultaine, cocamidopropyl hydroxysultaine (glycerine free), product of Colonial Chemical, USA.
⁵Sodium decylglucosides hydroxypropylsulfonate, product of Colonial Chemical, USA.
⁶Sodium laurylglucosides hydroxypropylsulfonate, product of Colonial Chemical, USA.
⁷Sodium hydroxypropylsulfonate laurylglucoside crosspolymer, product of Colonial Chemical, USA.

The data provided in Table 2 show that the attenuation effects were also observed at greater acid concentrations than provided for in Table 1.

Table 3 provides the calculated weight loss of Indiana limestone core samples, post-acidizing, for acid formulations containing acid solutions at 28 wt % HCl in the presence of mmol concentrations of ACS grade (95⁺%) sulfonate salts.

TABLE 3

| | | | Sulfonate salt | Calcite |
|---|---|---|---|---|
| | HCl | | Concentration | Dissolved |
| Formulation | (wt %) | Sulfonate salt | (mmol) | (%) |
| 27 | 28 | NaDDBS⁸ | 2.87 | 86.5 |
| 28 | 28 | NaOS⁹ | 2.87 | 71.4 |
| 29 | 28 | KPFOS¹⁰ | 2.87 | 97.6 |
| 30 | 28 | NaTFMS¹¹ | 2.87 | 71.9 |

⁸Sodium dodecylbenzenesulfonate.
⁹Sodium octanesulfonate.
¹⁰Potassium perfluorooctanesulfonate.
¹¹Sodium trifluoromethanesulfonate.

The data provided in Table 3 show that the use of sulfonate salts in concentrations corresponding to the concentrations of surfactants used in the formulations of Tables 1 and 2 resulted in greater calcite dissolution. This shows how structure-property is a governing factor in attaining the desired retardation effect and not all sulfonate-based molecules provide the attenuation effect.

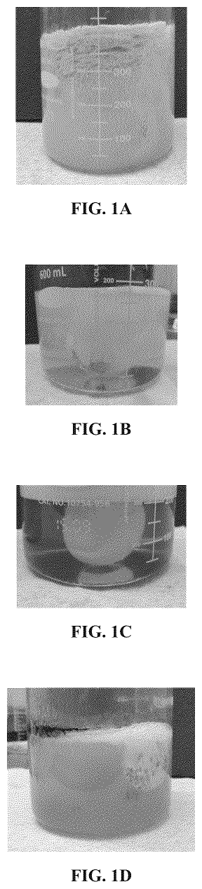

Selected digital photos of core samples used with Formulations 25 (FIG. 1A), 19 (FIG. 1B), 23 (FIG. 1C), and 3 (FIG. 1D) show the varying degrees of surface reactivity due to the presence of surfactant. FIG. 1A shows surface additive coverage and non-coverage. FIG. 1B shows the core fully coated with foam formed within the acid solution. FIG. 1C shows the formation of high density foam and full coverage of the core sample. FIG. 1D shows lack or minimal surface adsorption or foam formation on the core sample.

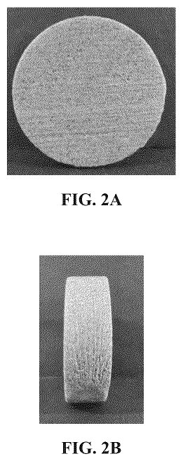

FIGS. 2A and 2B show the striation on the surface of a core sample treated with Formulation 16. Such surface striation may result from the rapid migration of CO₂ moving along the core sample to the top of the beaker minimizing the foam barrier between the rock and the acid such that where more foam and/or surfactant is present there is less dissolution and vice versa.

### Example 2—High Temperature/High Pressure Coreflow Experiment

A linear coreflow experiment was performed to evaluate the acid systems in terms of retardation behavior observed. The coreflow experiment was performed at a temperature of 300° F. and pressure of 3000 psi (pounds per square inch). In this Example, a linear coreflow experiment was performed using Formulation 5 described in Example 1.

For acidizing applications, the volume of acid required to dissolve a path in a core plug, for example, from the inlet to the outlet of the core sample, is indicative of acid stimulation behavior at the lab-scale. This value is commonly referred to as pore volume to breakthrough (PV_{BT}). Acid systems having greater acid-rock reactivity are associated with greater PV_{BT} values and acid systems having reduced acid-rock reactivity are associated with lesser PV_{BT} values under analogous testing conditions. Thus, reduced PV_{BT} values correlate with increased stimulation of a treated zone, as live acid can penetrate deeper into the reservoir. The live acid increases the relative permeability for oil and gas to be produced.

Core preparation procedures. Core samples having a porosity ranging from 14.3 to 16.3% were selected for this experiment. The absolute permeability for each DI-H₂O saturated core sample was measured in a horizontal fashion using a high temperature, high pressure (HT/HP) coreflow apparatus equipped with a 12″ coreholder. The permeability was calculated by flowing DI-H₂O through the core sample at various flow rates (for example, ranging from 0.5 to 4 cubic centimeters per minute (cc/min)) until the flow rate stabilized. For each flow rate, the average differential pressure across the core (DP) was recorded and applied to Darcy's equation to determine the initial permeability.

Table 4 provides a summary of coreflow data collected for 12-inch outcrop Indiana limestone core samples treated with different acid systems at 300° F., 3000 psi, and 2 cc/min flow rate.

TABLE 4

| | | | Core |
|---|---|---|---|
| | | Core Length | Diameter |
| Fluid ID | PV_{BT} | (inch) | (inch) |
| Formulation 5 | 0.55 | 12 | 1.5 |
| 15 wt % HCl | 1.31 | 12 | 1.5 |
| 15 wt % SXE | 0.70 | 12 | 1.5 |

Preparation of the emulsified acid system SXE was as follows. The assigned ratios for the dispersed and continuous phases were 70% and 30%, respectively. The dispersed phase was comprised of 15 wt % HCl in the presence of a corrosion inhibitor (0.6 v %), while the continuous phase consisted of diesel and an emulsifier (0.6 v %). For a typical procedure, diesel was first added to a 1-L Waring variable speed laboratory blender. While mixing at medium speed, the emulsifier was added and thoroughly mixed. A stock solution of 15 wt % HCl was prepared and added to a 500-mL separatory funnel in order to permit dropwise addition of the aqueous phase to the organic phase. Under constant high-speed mixing, the acid was continuously added dropwise to the diesel phase. Upon complete addition of the acid, the mixture was permitted to stir for an additional 5 minutes prior to characterization to ensure homogeneity of the resultant emulsion. The electrical conductivity was measured for all prepared emulsions and determined to be zero thus, confirming the successful formation of an acid-in-diesel emulsion in which case all HCl is encapsulated within the emulsion droplets. Successful formation of the emulsified acid was also confirmed from benchtop droplet tests. Accordingly, the as-prepared emulsion was added dropwise to a beaker of DI-H2O, in which case, the emulsion did not disperse in the water, instead spherical droplets formed on the bottom of the beaker which is indicative of encapsulation of the aqueous phase in the diesel layer.

Formulation 5 provided an estimated 58% reduction in PV_{BT} as compared to 15 wt % HCl without surfactant added, while a decrease of 20% was achieved as compared to 15 wt % emulsified acid (SXE).

While only a limited number of embodiments have been described, those skilled in the art having benefit of this disclosure will appreciate that other embodiments can be devised which do not depart from the scope of the disclosure.

Although the preceding description has been described here with reference to particular means, materials and embodiments, it is not intended to be limited to the particulars disclosed here; rather, it extends to all functionally equivalent structures, methods and uses, such as those within the scope of the appended claims.

The presently disclosed methods and compositions may suitably comprise, consist or consist essentially of the elements disclosed and may be practiced in the absence of an element not disclosed. For example, those skilled in the art can recognize that certain steps can be combined into a single step.

Unless defined otherwise, all technical and scientific terms used have the same meaning as commonly understood by one of ordinary skill in the art to which these systems, apparatuses, methods, processes and compositions belong.

The ranges of this disclosure may be expressed in the disclosure as from about one particular value, to about another particular value, or both. When such a range is expressed, it is to be understood that another embodiment is from the one particular value, to the other particular value, or both, along with all combinations within this range.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” or “optional” mean that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

1. An acidizing treatment for carbonate reservoir comprising:
a. a surfactant comprising one or more of C₈-C₃₀-alkyloxyglycoside-substituted hydroxysultaine, C₈-C₃₀-alkylamidopropyl hydroxysulfobetaine, poly(diallyldimethylammonium chloride), C₈-C₃₀-alkyl amido alkylamine oxide, C₈-C₃₀-alkyl-amido amine oxide, C₈-C₃₀-alkyl amine oxide, C₈-C₃₀-alkyl aryl amine oxide, C₈-C₃₀-alkyl polyether phosphate, C₈-C₃₀-alkyl polyether phosphonate, C₈-C₃₀-alkyl ether phosphonate, C₈-C₃₀-alkyl amido ammonium propyl sulfonate, C₈-C₃₀-alkyl amido ammonium vinyl sulfonate, C₈-C₃₀-alkyl ether sulfonate, C₈-C₃₀-alkyl amido ammonium propyl sulfonate, C₈-C₃₀-alkyl ether sulfonate, alpha olefin sulfonate, C₈-C₃₀-alkyl benzene sulfonate, C₈-C₃₀-alkyl ethoxy carboxylate, C₈-C₃₀-alkylphenol ethoxylate carboxylate, C₈-C₃₀-alkyloxyglycoside-substituted hydroxysultaine crosspolymer, and C₈-C₃₀-alkyl amido ammonium carboxylate; and
b. an aqueous acid solution or mixture,
where the surfactant is configured to partially or fully adsorb on a carbonate formation to retard the partial dissolution of the formation

2. The acidizing treatment of claim 1, where the surfactant generates foam, thereby retarding the partial dissolution of the formation.

3. The acidizing treatment of claim 1, where the surfactant comprises one or more of sodium decylglucosides hydroxypropylsulfonate, sodium laurylglucosides hydroxypropylsulfonate, and sodium hydroxypropylsulfonate laurylglucoside crosspolymer.

4. The acidizing treatment of claim 1, where the surfactant comprises one or more compounds of formulas II, or III: 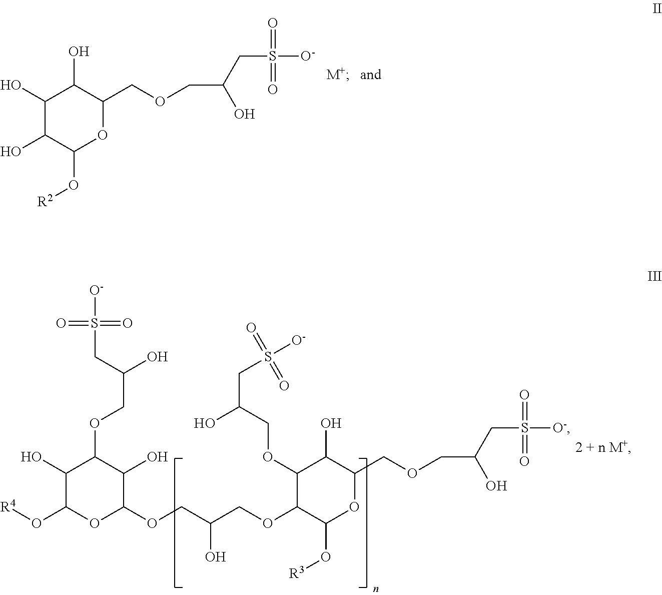
wherein R¹, R², R³ are independently C₈-C₃₀-alkyl groups, n=1-20, and M is a metal.

5. The acidizing treatment of claim 1, where the surfactant is present in a concentration in a range of from about 0.01 gallons per 1000 gallons (gpt) to about 70 gpt.

6. The acidizing treatment of claim 1, where the aqueous acid solution or mixture comprises an acid selected from the group consisting of an organic acid, and inorganic acid, and combinations thereof.

7. The acidizing treatment of claim 6, where the acid comprises hydrochloric acid, nitric acid, phosphoric acid, hydrofluoric acid, hydrobromic acid, perchloric acid, fluoroboric acid, formic acid, acetic acid, citric acid, lactic acid, sulfamic acid, chloroacetic acid, derivatives, or mixtures thereof.

8. The acidizing treatment of claim 1, where the aqueous acid solution or mixture comprises an acid present at a concentration of from about 5 wt % to 35 wt % based on the total weight of the acidizing treatment.

9. The acidizing treatment of claim 1 further comprising one or more additives selected from the group consisting of oxidizing agents, lost circulation materials, scale inhibitors, clay stabilizers, corrosion inhibitors, paraffin inhibitors, asphaltene inhibitors, penetrating agents, clay control additives, iron control additives, friction reducers, oxygen scavengers, sulfide scavengers, foamers, bactericides, derivatives thereof, and combinations thereof.

10. The acidizing treatment of claim 1 further comprising one or more mutual solvents.

11. A method of reducing the reactivity of acidizing treatment, comprising:
introducing the acidizing treatment of claim 1 into a wellbore such that the acidizing treatment contacts the formation.

12. The method of claim 11, further comprising:
combining the surfactant and the aqueous acid solution or mixture prior to introducing the acidizing treatment into the wellbore.

13. The method of claim 11, where introducing the acidizing treatment into a wellbore comprises:
introducing an aqueous solution of the surfactant and the aqueous acid solution or mixture simultaneously in a same tubing; and
allowing the acidizing treatment to form in situ within the tubing, or within the formation.

14. The method of claim 11, where introducing the acidizing treatment into a wellbore comprises:
introducing an aqueous solution of the surfactant and the aqueous solution of acid in different tubings; and
allowing the acidizing treatment to form in situ within the formation.

15. The method of claim 11, where introducing the acidizing treatment into a wellbore comprises:
introducing an aqueous solution of the surfactant and the aqueous solution of acid consecutively; and
allowing the acidizing treatment to form in situ within the formation.

16. The method of claim 15, where the surfactant is introducing first into the wellbore.

17. The method of claim 11, where the acidizing treatment is introduced into the wellbore via coiled tubing or bullheading in a production tube.

18. The method of claim 11, where the acidizing treatment is in contact with the formation for a time ranging from about 1 hour to about 12 hours.
